(19) United States
(12) Patent Application Publication
(10) Pub. No.: US 2020/0372445 A1
(43) Pub. Date: Nov. 26, 2020

(54) GENERATING RECOMMENDATIONS BASED ON STORAGE AVAILABILITY

(71) Applicant: International Business Machines Corporation, Armonk, NY (US)

(72) Inventors: Igor S. Ramos, Round Rock, TX (US); Devon E. Mensching, Austin, TX (US); Kimberly J. Taft, Austin, TX (US)

(21) Appl. No.: 16/420,871

(22) Filed: May 23, 2019

(51) Int. Cl. G06Q 10/08; G06Q 30/06; G06Q 10/04; G06K 9/00

(52) U.S. Cl. CPC G06Q 10/087; G06K 9/00201; G06Q 10/04; G06Q 30/0631

(57) ABSTRACT

Providing prior-purchase (prior-acquisition) notification determining available storage capacity based on dimensions of total space for storage, dimensions of occupied space for storage, and attributes of available space for storage. Available storage capacity is based on dimensions of total storage capacity and occupied storage space. Identification of a product (item) selected by the user for purchase or acquisition is made. A profile of the product that includes storage requirements is retrieved, and storage requirements include required storage space and storage space attributes. A storage option is determined based on the product selected, the storage requirements of the product selected, and the available storage capacity. A notification recommending a storage option is generated, based on the storage requirements of the product, available storage space, and the attributes of the available storage space, and the notification is sent to a computing device of the user prior to acquiring the product.

### FIELD OF THE INVENTION

The present invention relates generally to the field of space utilization, and more particularly to generating recommendations based on available storage space.

### BACKGROUND OF THE INVENTION

Supply distribution logistics rely on temporary storage of products prior to transportation and delivery. Storage can be determined as an area, considering a footprint of items to be stored, or as a space, considering three dimensional properties of items to be stored. Efficient use of storage has dependencies on determining the area or volume of storage as well as determining the area or volume to be occupied by acquired items.

Use of technology enables real-time determination of available storage, and may utilize sensors or cameras with dimension calibration capability. Properly positioned, such sensors or cameras may calculate storage capacity and determine occupied storage areas or spaces from available storage.

### SUMMARY

Embodiments of the present invention disclose a method, computer program product, and system for providing a recommendation regarding storage of items prior to acquiring the items. The method for providing the recommendation provides for one or more processors to determine available storage capacity based on dimensions of total storage space, dimensions of occupied storage space, and attributes of each available storage space of the available storage capacity. The one or more processors determine an item selected by a user for acquisition. The one or more processors retrieve a profile for the item that includes storage requirements, in which the storage requirements include required storage space and storage space attributes. The one or more processors determine storage options available, based on the item selected, the storage requirements of the item selected, and the available storage capacity. The one or more processors generate a notification recommending an option of the storage options based on the storage requirements of the item selected for acquisition, available storage space, and the attributes of the available storage space, and the one or more processors send the notification to a computing device of the user prior to acquisition of the product.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 illustrates operational steps of a storage space program, inserted on a computing device within the distributed data processing environment of FIG. 1, in accordance with an embodiment of the present invention.

FIG. 3 depicts a block diagram of components of a computing system, including a computing device capable of operationally performing the storage space program, in accordance with an embodiment of the present invention.

### DETAILED DESCRIPTION

Embodiments of the present invention recognize that acquiring bulk orders of products and storing the products presents a need for reconciling the space for storage and associated attributes with the storage requirements of the acquired bulk order. Embodiments of the present invention recognize that knowledge of available space for storage, alternatively referred to as storage space, and the type of storage space as defined by associated attributes, enables optimized utilization of storage space, avoids over or under ordering of products, can improve unit cost savings, and avoid waste and other complications due to lack of information regarding available storage space and associated attributes.

Embodiments of the present invention provide a method, computer program product, and computer system for providing a notification and related recommendations for acquiring items based on storage information, prior to acquiring and storing the items. The method provides the notification and recommendations by determining available storage space based on measurement of total storage space and occupied storage space, as well as determining attributes associated with available storage space. Embodiments include detecting an item selected for acquisition or purchase from an online source or a digitized list, and subsequently storing the item. Embodiments also include retrieving storage requirements from a profile of the item that includes storage dimensions and storage attribute requirements of the item. Embodiments of the present invention determine storage options available based on the item selected, the storage requirements of the item selected, and the available storage space and associated attributes of the available storage space.

Further embodiments of the present invention generate a notification of whether the intended acquisition or purchase of an item can be stored in available storage space, and generate recommendations including an option of the available storage options associated with the storage requirements of the item that has been selected. The notification and recommendations are sent to a computing device of a user selecting the item before the user confirms purchase of the item, or for non-purchase activity, before acquisition of the item. Hereafter, for convenience and clarity, embodiments of the present invention will present discussion and example of acquiring “products” by “purchase”, however, it is understood by one of average skill in the art that embodiments presented herein may apply to a variety of activities involving acquiring and storing items, and are not limited by the type of item nor the means of acquisition.

Embodiments of the present invention recognize that storage space attributes are particular conditions of the storage space beyond the dimensional requirements, such as, but not limited to, temperature, humidity, weight restrictions, hazardous product restrictions, food quality restrictions, and location for frequent access. Embodiments of the present invention further recognize the storage options associated with the storage requirements include recommending down-sizing an order for purchase of the product if adequate storage space and associated attributes are unavailable, in which down-sizing may include recommending reducing a quantity of the purchase, reducing a unit size of the purchase, or canceling the order.

Embodiments further recognize recommending up-sizing an order of the product to achieve lower unit cost or less frequent re-order for the case in which additional storage space and associated attributes are available. In some embodiments of the present invention, actions may be taken to acquire items other than by purchasing. In such cases, determination of adequate storage space, or transportation space, is determined prior to a user commitment to acquire the items. For purposes of brevity and clarity, activity hereafter referred to as product items intended for purchase will be inclusive of non-purchase activity as well, with regards to consideration of storage space for the purchased or acquired items.

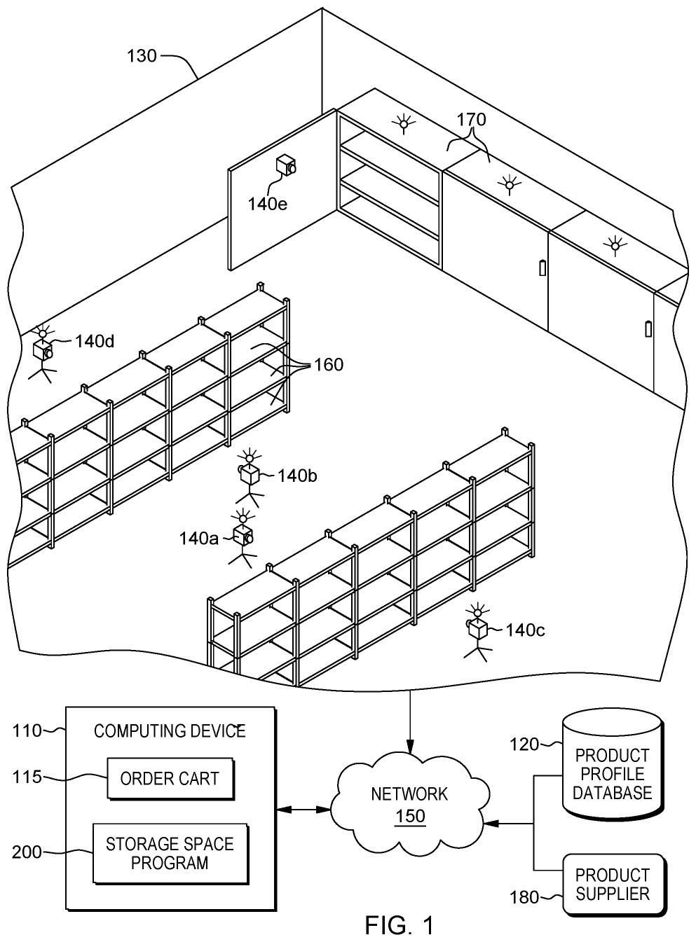

In some embodiments of the present invention, a storage space program (storage space program 200, see FIG. 1) generates a mapping of optimized storage arrangements, based on the dimensions of the acquired items and the available storage space meeting the storage attributes recommended for the acquired items. In some embodiments, the storage space program generates a map illustrating the optimal arrangement of the acquired items, and the map is included in a notification confirming the storage options of the acquired items. In some embodiments, the generated mapping of optimal storage arrangements includes a layer-by-layer positioning of acquired items, including organization of items to be stored in both horizontal and vertical layers. In some embodiments the optimal storage mapping includes an ordered list indicating particular items to position into a particular position of the storage space as well as the orientation of the item. The generated map may include an illustrated layout of item positions and orientations, by layer.

In some embodiments of the present invention, the optimized storage arrangement mapping is generated considering the attributes of the acquired items, and determines position and orientation of item storage, based on the attributes. For example, safety considerations keep containers of solvents and chemicals separate from food or clothing items, and clothing items are kept separate from items that include strong odors. For cases in which an item's storage orientation is designated, the generated mapping includes the storage position and orientation information of the acquired item to meet the designated conditions.

The present invention will now be described in detail with reference to the Figures. FIG. 1 is a functional block diagram illustrating a distributed data processing environment, generally designated 100, in accordance with an embodiment of the present invention. Distributed data processing environment 100 includes computing device 110, product profile database 120, storage area 130, and product supplier 180, all connected via network 150.

Network 150 can be, for example, a local area network (LAN), a telecommunications network, a wide area network (WAN), such as the Internet, a virtual local area network (VLAN), or any combination that can include wired, wireless, or optical connections. In general, network 150 can be any combination of connections and protocols that will support communications between data collection devices of storage area 130, product supplier 180, product profile database 120 and computing device 110, in accordance with embodiments of the present invention.

Product profile database 120 is a source of information included in a profile of a product. In some embodiments of the present invention, product profiles include product dimensions, storage footprint, weight, description, classification, and recommended storage information, referred to herein as “attributes” or “storage attributes” of the product. A classification of a product may include whether the product should be stored with or separate from other product types, such as cleaning supplies separated from food products, or clothing separate from building supplies. In some embodiments, an attribute of a product may include environmental control, such as temperature control for perishable food, or humidity control for artwork, certain paper documents, and electronics. Attributes may also include weight considered for storage placement and retrieval. In some embodiments, a product attribute includes information on the number of product items in an ordered unit, as well as the size (or volume) of a product item within the ordered unit. In some embodiments, as a product is included in order cart 115, the product profile information is retrieved and analyzed by storage space program 200.

Product supplier 180 is representative of one or more supply sources of products searched for by a user of computing device 110 and included in order cart 115, when selected. In some embodiments of the present invention, product supplier 180 is a manufacturer, whereas in other embodiments, product supplier 180 is a distribution warehouse enabling online search and order. In yet other embodiments, product supplier 180 may be a retail store with an online presence, interacting with end-user consumers on a local, large-area, national, or global level. In some embodiments, product supplier 180 may include product profile information, such as that found in product profile database 120. In some embodiments, a user of computing device 110 accesses product supplier 180 via network 150 and searches for products. Selected products are included by the user in order cart 115 and include product profile information from product profile database 120.

Storage area 130 includes storage shelves 160, controlled condition storage 170 and storage space sensors 140a, 140b, 140c, 140d, and 140e. In some embodiments of the present invention, storage area 130 is a facility for storage of large quantities of items. For example, in some embodiments, storage area 130 is a manufacturer's staging area for products ready to ship. In other embodiments, storage area 130 is a distribution center or warehouse for large quantities of products. In other embodiments, storage area 130 is a local grocery store, department store, building supply store, or other structures including a storage area. In one embodiment storage area 130 may be the storage area of a user's residence. In other embodiments, storage area 130 may be a transport vehicle or device.

Storage shelves 160 is depicted as tiered horizontal storage surfaces. Storage shelves 160 includes measurable surface space for each tier and measurable height between tiers of storage surfaces. Storage shelves 160 may include storage attributes, such as weight limitation, and designation of classification, such as liquid solvents, building supplies, or dry good foods. In some embodiments of the present invention, each classification space of storage shelves 160 includes a measurable amount of storage space which may be associated with a particular classification and one or more attributes. In some embodiments, products may be stored in an easy-to-access location of storage shelves 160, based on frequency of demand, weight, or size of the stored product.

Controlled condition storage 170 provides particular conditions for product storage within storage area 130. In some embodiments of the present invention, controlled condition storage 170 includes attributes of a particular condition, such as temperature control, humidity control, or other condition complying with the product profile storage requirements of a controlled condition. Controlled condition storage 170 includes a measurable storage space having a particular condition controlled to a target level or range. Controlled condition storage 170 may control multiple conditions, or may include other storage attributes in addition to one or more controlled conditions. For example, controlled condition storage 170 may be temperature controlled for fresh produce, and be classified for food content only, as well as a weight limit per square foot of area.

Storage space sensors 140a, 140b, 140c, 140d, and 140e represent a group of sensors positioned within storage area 130 to enable the determination of available storage space of storage shelves 160 and controlled condition storage 170. In some embodiments of the present invention, storage space sensors 140a, 140b, 140c, 140d, and 140e (collectively referred to as storage space sensors 140), are an array of optical sensors or cameras that can determine the occupied and/or unoccupied space of storage shelves 160 and controlled condition storage 170. In some embodiments, storage space sensors 140 communicate with storage space program 200 operating on computing device 110 via network 150. In other embodiments, storage space sensors 140a, 140b, 140c, 140d, and 140e may be communicatively connected to another computing device local to storage area 130 (not shown), which communicates to computing device 110 via network 150. In some embodiments of the present invention, one or more of storage space sensors 140a, 140b, 140c, 140d, and 140e may determine occupied and/or unoccupied storage space by use of one or combinations of optics, lasers, ultrasound, object recognition techniques, or other methods.

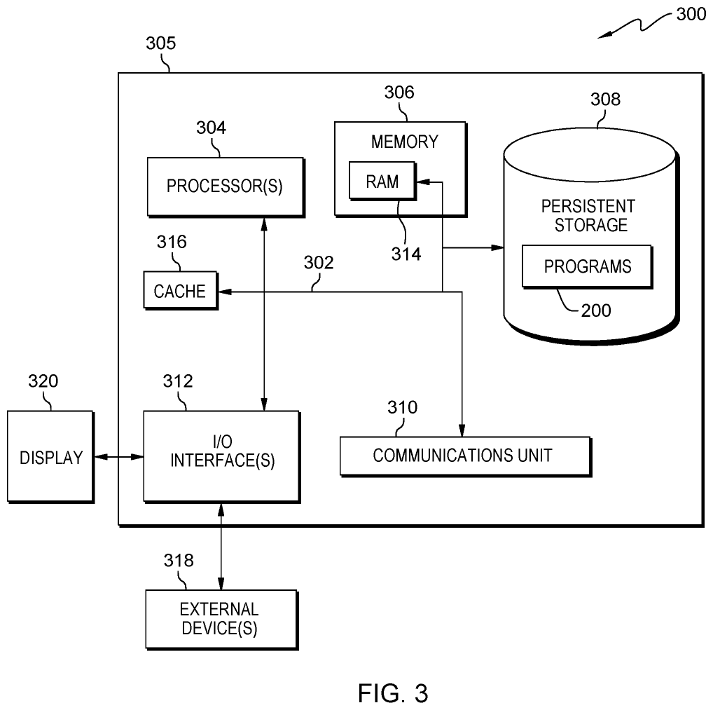

Computing device 110 is operated by a user to select products, generate a purchase list, confirm an acquisition offer, and/or place an online order via a user interface (not shown). Computing device 110 includes order cart 115 and storage space program 200. Computing device 110 can be a standalone computing device, a management server, a web server, a mobile computing device, or any other electronic device or computing system capable of receiving, sending, and processing data. In other embodiments, server computer 110 can represent a server computing system utilizing multiple computers as a server system, such as in a cloud computing environment. In another embodiment, computing device 110 can be a laptop computer, a tablet computer, a netbook computer, a personal computer (PC), a desktop computer, a personal digital assistant (PDA), a smart phone, or any other programmable electronic device capable of communicating with devices of storage area 130, product supplier 180, product profile database 120, and other computing devices (not shown) within distributed data processing environment 100 via network 150. In another embodiment, computing device 110 represents a computing system utilizing clustered computers and components (e.g., database server computers, application server computers, etc.) that act as a single pool of seamless resources when accessed within distributed data processing environment 100. Computing device 110 may include internal and external hardware components, as depicted and described in FIG. 3.

Order cart 115 is a displayed component of an ordering application accessed by a user of computing device 110. Order cart 115 identifies a product selected for order or acquisition from online access to product supplier 180. In some embodiments of the present invention, confirmed orders from order cart 115 may be saved and used in determining frequency of order and product order unit, size, and quantity. In some embodiments, storage space program 200 identifies product items in order cart 115 and determines whether a product size or order unit size provides benefit based on user preferences, such as conserving storage space, reducing unit cost of product, or reducing order frequency. In some embodiments, storage space program 200 provides a recommendation to a user generating an order in order cart 115, prior to the user acting on order cart 115, such as confirming and placing the order, making changes to order cart 115, or canceling order cart 115.

Storage space program 200 operates on computing device 110 and monitors available storage space in storage area 130 and determines if adequate storage space is available when detecting selected products in order cart 115. Storage space program 200 receives a one-time measurement of total storage space that may include storage attributes and classification of portions of storage space. In some embodiments, storage space program 200 receives online order selections from order cart 115, retrieves and analyzes product profile information from product profile database 120, and determines storage space and attribute requirements of selected products included in order cart 115.

In some embodiments of the present invention, storage space program 200 determines available storage space by determining the difference between the measurement of total storage space and the occupied storage space as determined by storage space sensors 140 from the measured total storage space. In some embodiments, storage space program 200 determines available storage space by considering classification and attribute information associated with the selected products in order cart 115. In some embodiments, storage space program 200 receives measurement of total storage space from storage space sensors 140. In other embodiments, measurements of total storage space are performed using manual techniques and input to storage space program 200 via computing device 110. Storage space program 200 includes user preferences in which aspects of storage space recommendations can be set by the user, such as saving storage space, providing easy-access location to high frequency ordered items, and reducing unit cost of ordered products.

In some embodiments of the present invention, storage space program 200 determines if alternate sizes or shipping units are available for selected products and, based on user preference, may include a message to the user recommending an up-size or down-size of products in order cart 115. In some embodiments, following a user preference prioritizing optimal storage space usage, storage space program 200 recommends changes to order cart products, selecting a product size or shipping unit size that meets demands with minimal storage requirements. In another embodiment, storage space program 200 recommends changing the order cart selections to available up-sized products to benefit from a lower unit cost, based on excess available storage space and user preferences to minimize cost.

In yet other embodiments, storage space program 200 may confirm the selection of products in the order cart having determined that alternate product or unit shipping sizes are not available, or may recommend canceling the selected products in the order cart based on a lack of available storage space and/or matching classification and attributes. In still other embodiments, storage space program 200 recommends changing the quantity of products selected in the order cart, based on available storage space (considering classification and attributes) and considering frequency of turnover of stored products, as determined from saved information from submitted order cart selections. In still other embodiments, storage space program 200 considers transportation space and attributes available for cases in which a user indicates intent to purchase or acquired items for which the user provides transportation.

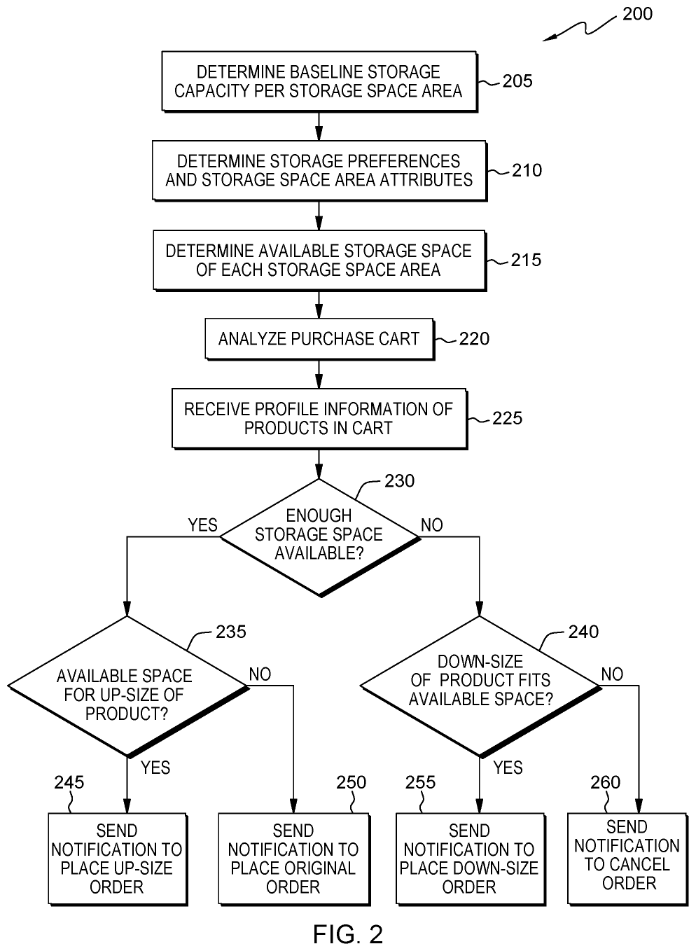

FIG. 2 illustrates operational steps of storage space program 200, operating on computing device 110 within distributed data processing environment 100 of FIG. 1, in accordance with an embodiment of the present invention.

In step 205, storage space program 200 determines a baseline storage capacity. The baseline storage capacity further includes determining a type and position of storage, which is determined for all collective storage. The aggregate of all types and positions of storage, hereafter, are collectively referred to as storage space, or storage space area. In some embodiments of the present invention, storage space program 200 determines the base level capacity of storage space for all storage space areas by calculating area and/or volume of spaces for storage based on sensor input, such as input from storage space sensors 140a, 140b, 140c, 140d, and 140e (FIG. 1). In other embodiments, the base level storage space capacity is determined by manual measurement and input to storage space program 200 via computing device 110 or other computing device (not shown) connected to network 150. In embodiments of the present invention, storage space program 200 determines the storage capacity of each storage space area, typically as a one-time activity. In some embodiments, if changes are made to the storage space area, such as adding or removing storage space from storage shelves 160 or controlled condition storage 170, storage space program 200 recalculates the base level of storage space capacity.

In step 210, storage space program 200 determines storage preferences and attributes associated with a storage space. In some embodiments of the present invention, storage space program 200 checks input received from the user of computing device 110 indicating the user preferences of priority for storage space program 200, such as optimizing available storage space, reducing unit cost of items purchased, or optimizing transportation of items. For example, storage space program 200 receives user preferences input via computing device 110, in which the user has applied the chosen preference to all storage space. User preferences of optimizing storage space may prioritize economy of storage space over other considerations, whereas cost reduction preferences prioritize lower unit cost of purchases by upsizing to larger volume or quantities over storage space required to store purchases. In some embodiments, when prioritizing transportation storage space or weight limitations, preference may be given to purchase size or quantities to accommodate available transportations space. For example, having determined the user preference for reducing unit cost of purchased products, storage space program 200 determines whether larger sized products are accommodated in available storages space of storage shelves 160, in order to benefit from a lower unit cost of the larger sized products. Determining that excess space is available on storage shelves 160, storage space program 200 generates a notification confirming available storage space and recommending the purchase of larger size products to benefit from a lower unit cost.

Storage space program 200 also determines attributes associated with each storage space area. In some embodiments of the present invention, storage space program 200 receives input from a user of computing device 110 indicating attributes associated with each area or space for storage. Attributes may include, but are not limited to dimensional limits such as length, width, and height, temperature control, humidity control, weight limits, ease of access, exposure to light, and designated product types, such as chemicals or food supply. Storage space program 200 associates attributes with each of the storage spaces, and applies the attributes in determination of available storage space depending on attribute requirements of the items to store. For example, an order of product intended for purchase is determined to occupy a particular amount of storage space, based on online profile information associated with the product. According to the profile information, storage of the product is recommended under controlled conditions. Storage space program 200 determines whether storage space having the particular controlled condition attributes, such as controlled condition storage 170, is available to store the intended order of product.

In step 215, storage space program 200 determines the available storage space of the collective storage space area. Storage space program 200 receives input from storage space sensors positioned within storage space areas, indicating occupied and unoccupied storage space for each storage area. Storage space program 200 determines the available storage space by calculating the occupied space in each storage space area and comparing the occupied space to the base level storage space for each storage space area. In some embodiments of the present invention, storage space program 200 calculates available storage space for each type of storage space area, which may be determined by weight limits, controlled conditions, location within storage area 130, vertical clearance, or other aspect of the storage space area. For example, in storage area 130, storage space sensors 140a, 140b, 140c, 140d, and 140e are a group of sensors positioned within storage area 130 to enable the determination of available storage space of storage shelves 160 and controlled condition storage 170. In the example, storage space sensors 140a, 140b, 140c, 140d, and 140e have a wireless connection to network 150 and the input from the storage sensors is accessible to storage space program 200 operating on computing device 110. Storage space program 200 compares the sensor input indicating the occupied storage space for each type of storage in storage area 130 to the previously determined base level storage capacity of each storage space area and determines the available storage space for storage shelves 160 and controlled condition storage 170 (FIG. 1).

In step 220 storage space program 200 analyzes the purchase cart. In some embodiments of the present invention, purchase of product is performed by accessing a product supplier online and selecting products for purchase, which are listed in a “cart,” which is an online page that may display product name, information, cost, and other information. The purchase of products and means of payment can be confirmed from the online cart. Storage space program 200 analyzes the contents of the cart prior to confirmation of purchase, and determines the products intended for purchase. For example, a user has accessed the web site of product supplier 180 over network 150 to search and find a particular set of products to purchase. The user finds and selects the products to be added to the user's “checkout cart” such as order cart 115, accessed from supplier 180′s web site. Prior to confirming purchase of the products, storage space program 200 analyzes order cart 115 and determines the products intended for purchase. In another embodiment, the user may generate a list of products intended to purchase at a “brick and mortar” store, for example, and storage space program 200 receives the list and determines the products intended for purchase.

In step 225, storage space program 200 receives profile information of the products in the cart. Having determined the products intended for purchase, storage space program 200 receives product profile information for the products from product profile database 120, prior to confirming purchase of the products. In some embodiments of the present invention, product profile database 120 may include information regarding the dimensional size, weight, and quantity of product units sold within an order. In some embodiments, product profile database 120 may also include storage attributes recommended for the product, as well as other information. In some embodiments, the profile information of the products intended for purchase may be accessible from the online product supplier. Storage space program 200 receives the product profile information and determines the type (attributes) and amount (calculated space) of storage space for the intended product order.

For example, storage space program 200 retrieves product profile information from product profile database 120 for products determined from analysis of order cart 115 of product supplier 180's website, displayed on a browser operated by computing device 110. Storage space program determines from the product profile information such as the dimensional size, weight, and quantity of product units sold within the order, and attributes recommended for the storage of the product intended for purchase. Storage space program 200 can utilize the product profile information to determine whether storage space with appropriate storage conditions is available.

In decision step 230, storage space program 200 determines whether enough storage space is available to store the products intended for purchase. In some embodiments of the present invention, storage space program 200 determines whether particular conditions are recommended for storage of the products, based on the profile information received. Additionally, storage space program 200 determines the dimensional space required to store the products intended for purchase as well as considering the prioritized preferences received as input from the user. For the case in which storage space program 200 determines that the storage area does include adequate storage space that includes attributes providing recommended conditions for product storage (step 230, “YES” branch), storage space program 200 determines whether the available storage space is adequate to recommend up-sizing the product order (decision step 235). In some embodiments of the present invention, up-sizing the product order may include increasing the number of units of the product in the order, and in other embodiments, up-sizing the product order may include selecting a larger size unit, possibly increasing the amount of storage space the products would occupy, but providing an opportunity for a lower unit cost for purchase. For example, storage space program 200 determines from the product profile information that the products intended for purchase will occupy a certain foot print area and height for storage and determines that weight and recommended storage conditions are easily met by storage shelves 160.

In some embodiments of the present invention, a storage space program 200 generates a mapping of optimized storage arrangements, based on the dimensions of the products intended for purchase and the available storage space meeting the storage attributes recommended for the products intended for purchase. In some embodiments, the storage space program generates a map illustrating the optimal arrangement of the products, and the map is included in a notification confirming the storage options of the acquired items. For example, the generated mapping of optimal storage arrangements includes a layer-by-layer positioning of the products intended for purchase, including the organization of products to be stored in both horizontal and vertical layers. The optimal storage mapping includes an ordered list indicating particular positions and orientations of products into a storage space to optimize the storage space used. The generated map may include an illustrated layout of product positions and orientations, by layer, and the optimized storage arrangement mapping is generated considering the attributes of the products intended for purchase.

In some embodiments, the attributes of the items are leveraged to further refine optimal storage arrangements for the items. In one such embodiment, some items have a requirement of being stored upright or on their side, etc., and those requirements are accounted for, using a set of rules, when determining the optimal storage arrangement. In another example, two items include attributes that indicate that the items are not to be stored within a given proximity of each other. In some such embodiments, the arrangement of items is based at least in part on a set of rules that account for safety. For example, a large storage crate is being shipped overseas and includes a number of different products. Storage space program 200 accounts for safety concerns related to various items when determining the optimal organization of those items within the shipping container. In this example, a container holding liquid would be unsafe to store on its side due to the risk of leakage, so storage space program 200 only uses organization options that store the container upright with respect to the container opening. Storage space program 200 also determines that certain types of items are not to be stored near each other. In this example, storage space program 200 also determines that clothing is not be stored next to products that emit a strong odor that may permeate the clothing, or next to the container since, if the packaging breaks, the liquid could cause stains and ruin the clothing. As such, storage space program 200 generates an optimal storage solution for those items based on their dimensions as well as the physical and/or chemical characteristics associated with each of the items to be stored.

In decision step 235, storage space program 200 determines whether storage space is available for up-sizing of products intended for purchase. In some embodiments, storage space program 200 receives product profile information that includes whether alternative product size or alternative number of units in an order are available. Determining alternative size or unit numbers are available for the products included in the order, storage space program 200 calculates the additional storage space that an up-sized order would occupy. Storage space program 200 determines whether the additional space is available, and also considers the user's priority preferences received. For the case in which storage space program 200 determines the additional space to up-size and store the order of products intended for purchase is available and consistent with user priority preferences (step 235, “YES” branch), storage space program 200 generates a recommendation to place the up-sized order. In step 245, storage space program 200 sends the recommendation as a notification to the user to place the up-sized order, prior to confirming the purchase of the order. The user, agreeing with the recommendation, adjusts the order to include up-sized products and subsequently confirms the purchase and places the up-sized order.

For example, having determined that storage shelves 160 has adequate storage space for a product order listed in order cart 115, storage space program 200 determines whether alternative product size or unit quantities to up-size the order are available for the product by referencing the product profile information received from product profile database 120. Storage space program 200 determines that larger sizes are available for the products in order cart 115, and the larger size offers a reduction of unit cost. Storage space program 200 recalculates the storage space required for the up-sized product order and determines whether available storage space and associated attributes accommodate the recalculated storage space of the up-sized order. Storage space program 200 determines that the user priority preference received places a priority on lowering unit costs of products when such opportunity exists. Storage space program 200 generates a recommendation to place the up-sized order and sends the recommendation in a notification to the user placing the order, prior to confirming the purchase of the order. The user receives the notification recommending the up-sized order, agrees with the recommendation and adjusts the order to include the up-sizing of the products. The user subsequently confirms the purchase of the up-sized products and places the order. Receiving the recommendation prior to confirming and paying for the purchase order enables the user to adjust the order to include the larger sizes and benefit from the reduction in unit cost.

For the case in which storage space program 200 determines that storage space for up-sized products is not available, or up-sized products are not offered (step 235, “NO” branch), storage space program 200 generates a recommendation to place the original order. In step 250, storage space program 200 sends the recommendation as a notification to the user to place the original order, prior to the user confirming and paying for the order. The user, agreeing with the recommendation of the notification to place the original order confirms the purchase and places the original order.

For example, storage space program 200 determines that storage shelves 160 has inadequate storage space for up-sizing the product order listed in order cart 115, or determines that the product profile information indicates no alternative size or unit quantity are available for the products in order cart 115. Storage space program 200 generates a recommendation to place the original order and sends the recommendation in a notification to the user placing the order, prior to confirming the purchase of the order. In some embodiments, storage space program 200 considers the user preference placing a priority on conserving storage space, and subsequently recommends in a notification to the user to place the original order, even if storage shelves 160 could marginally accommodate an up-sized product order. The user receives the notification recommending placement of the original order, agrees with the recommendation, and confirms the purchase and places the original order.

Returning to decision step 230 and considering the case in which storage space program 200 determines that the storage area includes inadequate storage space with attributes providing recommended conditions for the product storage (step 230, “NO” branch), storage space program 200 determines whether down-sizing the product order enables the products to fit within available storage space providing recommended attributes for storage (decision step 240). In some embodiments of the present invention, down-sizing the product order may include reducing the number of units in the order, whereas in other embodiments, down-sizing the product order may include selecting a smaller size unit, both of which reduce the amount of storage space the products would occupy. For example, storage space program 200 determines a foot print and height for the products intended for purchase, and conditions recommended for storage from the product profile information received from product profile database 120. Storage space program 200 determines that the products intended for purchase require storage in controlled condition storage 170, and further determines that the storage area includes inadequate storage space for the current intended product order in controlled condition storage 170.

For the case in which storage space program 200 determines that down-sizing the product order enables the products to fit within available storage space (step 240, “YES” branch), storage space program 200 generates a recommendation to down-size the product order and in step 255, sends a notification including the down-sizing recommendation to the user. In some embodiments of the present invention the product order may be down-sized by selecting reduced size or volume containers of the products intended for purchase. In other embodiments, the quantity ordered or number of units per order are reduced to down-size the order.

For example, storage space program 200 determines storage shelves 160 does not have enough free storage space to fit the products in order cart 115. Storage space program 200 determines from product profile information received from product profile database 120 that the products in order cart 115 are available in smaller sizes or lower unit counts. Storage space program determines that changing to the smaller size products allows the products in order cart 115 to fit in the available space on storage shelves 160. Storage space program 200 generates a recommendation to place a down-size order and sends the recommendation in a notification to the user of computing device 110 prior to the user making payment and confirming the order. The user views the notification, agrees with the recommendation, adjusts the order to include the smaller size products, and confirms and places the order.

Returning to the case in which storage space program 200 determines that down-sizing of products intended for purchase do not fit in the available storage space (step 240, “NO” branch), or alternatively, the products intended for purchase do not include alternative product size or unit quantities enabling down-sizing of the order, storage space program 200 generates a recommendation to cancel the order, and in step 260, sends the recommendation to cancel the order in a notification to the user. For example, storage space program determines from the product profile information received from product profile database 120 that the products in order cart 115 do not offer alternative product sizes or reduced unit quantities for an order, that would enable down-sizing of the order. Responsive to determining inadequate storage space to store the products in order cart 115 and unable to down-size the order, storage space program 200 generates a recommendation to cancel the order and sends the recommendation to the user in a notification.

In some embodiments of the present invention, storage space program 200 automatically performs an up-size or down-size order adjustment, based on user priority preferences and determination of available storage space with attributes recommended for storage conditions of the products intended for purchase. In some embodiments, storage shelves 160 represents a pantry or cupboards for a household or restaurant, and controlled condition storage 170 represents appliances providing temperature control for food or other products. In some embodiments, the user preferences include identification of “must have” items as prioritized over other items included in an order cart or purchase list analyzed by storage space program 200. In some embodiments of the present invention, storage space program 200 determines consumption habits, frequency of purchase, and shelf life of products ordered, based on retaining the order information history. In other embodiments, storage space program 200 includes priority purchases in recommendations, based on historic purchases, user identified priority items, and available storage space.

In some embodiments of the present invention, storage space of transportation vehicles or devices is designated as a type of storage space area, and are included in storage space area analysis and calculations by storage space program 200. Attributes of transportation storage space may include, weight limits, and controlled conditions.

FIG. 3 depicts a block diagram of components of computing system 300, which includes computing device 305. Computing device 305 includes components and functional capability similar to computing device 110 (FIG. 1), in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 305 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306, cache memory 316, and persistent storage 308 are computer readable storage media. In this embodiment, memory 306 includes random access memory (RAM) 314. In general, memory 306 can include any suitable volatile or non-volatile computer readable storage media.

Storage space program 200 is stored in persistent storage 308 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of distributed data processing environment 100. In these examples, communications unit 310 includes one or more network interface cards. Communications unit 310 may provide communications through the use of either or both physical and wireless communications links. Storage space program 200 may be downloaded to persistent storage 308 through communications unit 310.

I/O interface(s) 312 allows for input and output of data with other devices that may be connected to computing system 300. For example, I/O interface 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention, e.g., storage space program 200 can be stored on such portable computer readable storage media and can be loaded onto persistent storage 308 via 1/0 interface(s) 312. 1/0 interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for determining storage accommodation of items prior to acquiring the items, the method comprising:
one or more processors determining available storage capacity based on dimensions of total space for storage, dimensions of occupied space for storage, and attributes of available space for storage;
the one or more processors determining an item selected by a user for acquisition;
the one or more processors retrieving a profile for the item that includes storage requirements, wherein the storage requirements include required storage space and storage space attributes;
the one or more processors determining options of available space for storage based on the item selected, the storage requirements of the item selected, and the available storage capacity;
the one or more processors generating a notification recommending an option of the storage options based on the storage requirements of the item selected for acquisition, available storage space, and the attributes of the available storage space; and
the one or more processors sending the notification to a computing device of the user prior to acquisition of the product.

2. The method of claim 1, further comprising:
in response to determining that the available storage space and the attributes of the available storage space cannot accommodate the storage requirements of the item, the one or more processors determining whether a down-size change to the selection of the item is accommodated by the available storage space and the attributes of the available storage space; and
in response to determining that the available storage space and attributes of the available storage space accommodate a down-size change to the selection of the item, one or more processors including the down-size recommendation in the notification.

3. The method of claim 1, further comprising:
in response to determining that the available storage space and storage attributes exceed the storage requirements of the item to be stored, the one or more processors recommending an up-size change to the selection of the item in the notification.

4. The method of claim 1, further comprising:
in response to determining that the available storage options fail to meet the storage requirements of the item, the one or more processors identifying one or more alternative items that do meet the storage requirements; and
the one or more processors recommending a selection of the one or more alternative items as alternatives for acquisition in the notification.

5. The method of claim 1, wherein determining an item selected by the user for acquisition includes analyzing a product in an order cart of an online supplier selected for purchase by the user.

6. The method of claim 1, further comprising:
the one or more processors determining an optimal position and orientation within the available space for storage for the item selected for acquisition.
wherein determining the item selected for acquisition by the user includes analyzing a list received by the one or more processors.

7. The method of claim 1, wherein an attribute of a space for storage accommodates a requirement of storage for a particular item intended for acquisition.

8. The method of claim 1, further comprising:
the one or more processors receiving a priority preference of storage options from user input, wherein the user priorities are selected from the group consisting of: optimization of storage space, cost savings on purchases, ease of access of stored items, and priority of an item; and
the one or more processors modifying the notification recommending an option of the storage options based on the priority preference received from the user input.

9. The method of claim 1, further comprising:
the one or more processors determining a frequency of acquisition of an item, based on a history of acquisition; and
the one or more processors determining a priority of items for acquisition, based on the frequency of acquisition of the item.

10. The method of claim 1, wherein the storage space capacity includes a space for storage for transportation.

11. The method of claim 1, wherein the dimensions of total space for storage and the dimensions of occupied space for storage, are determined by applying one or more sensors to the respective space for storage.

12. The method of claim 11, wherein the one or more sensors are cameras, configured to detect the dimensions of total space for storage and the dimensions of occupied space for storage.

13. A computer program product for determining storage accommodation of items prior to acquiring the items, the method comprising:
one or more computer readable storage media and program instructions stored on the one or more computer readable storage media, the program instructions comprising:
program instructions to determine available storage capacity based on dimensions of total space for storage, dimensions of occupied space for storage, and attributes of available space for storage;
program instructions to determine an item selected by a user for acquisition;
program instructions to retrieve a profile for the item that includes storage requirements, wherein the storage requirements include required storage space and storage space attributes;
program instructions to determine options of available space for storage based on the item selected, the storage requirements of the item selected, and the available storage capacity;
program instructions to generate a notification recommending an option of the storage options based on the storage requirements of the item selected for acquisition, available storage space, and the attributes of the available storage space; and
program instructions to send the notification to a computing device of the user prior to acquisition of the product.

14. The computer program product of claim 11, further comprising:
in response to the available storage space and the attributes of the available storage space failing to accommodate the storage of the item, program instructions to determine whether a down-size change to the selection of the item is accommodated by the available storage space and the attributes of the available storage space;
in response to determining that the available storage space and attributes of the available storage space accommodate a down-size change to the selection of the item, program instructions to include the down-size recommendation in the notification.

15. The computer program product of claim 11, further comprising:
in response to the available storage space and storage attributes exceeding the storage requirements of the item to be stored, program instructions to recommend an up-size change to the selection of the item in the notification.

16. The computer program product of claim 11, further comprising:
based on a determination that the available storage options fail to meet the storage requirements of the item, program instructions to identify one or more alternative items that do meet the storage requirements; and
program instructions to recommend a selection of the one or more alternative items as alternatives for acquisition in the notification.

17. A computer system for providing a recommendation regarding storage of items prior to acquiring the items, the method comprising:
one or more computer processors;
one or more computer readable storage media; and
program instructions stored on the one or more computer readable storage media, the program instructions comprising:
program instructions to determine available storage capacity based on dimensions of total space for storage, dimensions of occupied space for storage, and attributes of available space for storage;
program instructions to determine an item selected by a user for acquisition;
program instructions to retrieve a profile for the item that includes storage requirements, wherein the storage requirements include required storage space and storage space attributes;
program instructions to determine options of available space for storage based on the item selected, the storage requirements of the item selected, and the available storage capacity;
program instructions to generate a notification recommending an option of the storage options based on the storage requirements of the item selected for acquisition, available storage space, and the attributes of the available storage space; and
program instructions to send the notification to a computing device of the user prior to acquisition of the product.

18. The computer system of claim 17, wherein the dimensions of total space for storage and the dimensions of occupied space for storage, are determined by applying one or more sensors directed to the respective space for storage, and configured to detect the dimensions of total space for storage and the dimensions of occupied space for storage, wherein the one or more sensors are selected from a group consisting of a camera and a sonar-based sensor.

19. The computer system of claim 17, further comprising:
program instructions to determine a frequency of acquisition of an item, based on a history of acquisition; and
program instructions to determine a priority of items for acquisition, based on the frequency of acquisition of the item.

20. The computer system of claim 17, wherein the storage space capacity includes a space for storage for transportation.
